(19) United States
(12) Patent Application Publication
(10) Pub. No.: US 2023/0162234 A1
(43) Pub. Date: May 25, 2023

(54) AUTOMATED PROFILE SHARING SYSTEM

(71) Applicant: Capital One Services, LLC, McLean, VA (US)

(72) Inventor: Walker Ramirez, Frisco, TX (US)

(21) Appl. No.: 17/535,229

(22) Filed: Nov. 24, 2021

(51) Int. Cl. G06Q 30/02; G06Q 20/38; G06Q 20/32

(52) U.S. Cl. CPC G06Q 30/0265; G06Q 20/3276; G06Q 20/3829; G06Q 30/0201

(57) ABSTRACT

Methods, systems, devices, and computer-readable media for an automated profile sharing system are provided. The system may generate a buying profile associated with a user. The buying profile may include a plurality of information. A portion of the buying profile information may be encrypted and the buying profile may be transmitted to a computing device associated with a vendor. The encrypted portion of the buying profile information transmitted to the computing device associated with the vendor may be unreadable to the vendor. Upon receiving authorization to make an additional portion of the information included in the buying profile accessible to the vendor, a decryption key may be transmitted to the vendor computing device to decrypt one or more portions of the encrypted portions of the buying profile data.

### CROSS-REFERENCE TO RELATED APPLICATIONS

This application is related to U.S. Pat. Application No. 17/104,684, filed on Nov. 25, 2020, the content of which is incorporated herein by reference in its entirety.

### FIELD OF USE

Aspects of the disclosure relate generally to methods of automated sharing of profile information.

### BACKGROUND

Among the various stages of auto buying, consumers often express the most disdain for the negotiation stage of the process. For the consumer, navigating the auto buying process typically involves identifying a vehicle of interest and then visiting an automobile buying establishment, such as a dealership or an independent seller, to conduct a test drive and to discuss and/or negotiate the financial aspects of a purchase of the vehicle. This final portion of the process - discussing and/or negotiating the financial aspects of a purchase - is often time-consuming and repetitive because, in order for the consumer to gauge whether a deal being offered by a seller is a good one, the consumer must often visit with multiple sellers and engage multiple times in a similar negotiation process. Each such visit generally involves the sharing of the same or similar information, such as the consumer’s personal information, driver’s license, insurance, or lender-assigned stipulations, such as proof of employment, proof of income, proof of residency, etc, so that the seller and/or lender may make an informed assessment of the consumer’s credit-worthiness and/or financial ability to purchase the vehicle of interest. However, while necessary, the repetitive nature of the manual information sharing presents a challenge as it may result in frustration on the part of the consumer - causing the consumer to prematurely end a visit with the seller or to limit the number of sellers that the consumer visits. This in turn, may have a negative effect on sellers, as it may result in an increased likelihood that sellers might miss out on otherwise committed and qualified buyers. Current buying processes, however, do not provide any automated means for sharing such information between a consumer and seller and the various systems used by such sellers to collect and maintain such information. Moreover, these challenges may not be unique to the auto buying process and may also be present in other buying contexts, such as in the home buying context, renting an apartment, purchasing insurance, requests for proposals, or other marketplaces of goods or services, where a consumer routinely must share personal information, preferences, prequalification letters, proof of funds, or the like and where suppliers must retrieve relevant, verifiable information from the consumer in order to extend an offer. Accordingly, there is a need to automate the sharing of consumer information with sellers and their various systems in a manner that is seamless, secure, and controllable by the consumer.

### SUMMARY

The following presents a simplified summary in order to provide a basic understanding of various aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the detailed description below.

Aspects of the disclosure relate to systems, apparatuses, computer-readable media, and methods for the automated sharing of information. The automated sharing may be accomplished using a profile associated with a consumer, such as an auto buying profile, a house buying profile, or the like. With the buying profile, the consumer’s demographic data and other relevant data, such as proof of income, driver’s license information, insurance information, proof of funds, and/or the like may be maintained in a central and secure profile associated with the consumer. The profile may additionally include information indicating the consumer’s preferences - such as vehicle feature preferences (e.g., color, size, transmission type, model year, wheel size, price range, etc.), housing feature preferences (e.g., geographical area, number of bedrooms, number of bathrooms, floors, etc.), and/or the like. A target item associated with the consumer’s preferences or features may be identified. In some cases, the items similar to the target item may additionally be identified. The purpose of identifying the similar items may be to optimize the consumer’s utility under constraints placed by consumer’s budget and or in stock/available in inventory. This further allows for interoperability among different manufacturers of goods or services that may include different features from one another or, in some cases, the same set of features but by different names (e.g., BMW’s XDRIVE and AUDI’s QUATTRO, which both refer to all-wheel drive). The target item and/or the similar items may additionally be included in the buying profile. The consumer may maintain control over the buying profile and may update the information stored therein throughout the buying process. The consumer may share information associated with the buying profile to other individuals. The consumer may manage or control which portions of the information from the buying profile may be shared with which individuals, when each individual may be able to view the information, and for how long. The consumer may transmit the buying profile to a device associated with the individuals or may otherwise provide such individuals with access to the determined portions of the buying profile. For instance, the consumer, using a device such as his mobile device, may cause a profile sharing application executing thereon to generate a unique code, such as quick response (QR) code or a bar code, or a hyperlink, or the like for sharing with other individuals. The generated unique code or hyperlink may be output to a display of the consumer’s mobile device and presented to an individual, such as a seller, to be scanned by a device associated with the individual. Scanning the code or accessing the hyperlink may cause at least some of the information associated with the profile to be output to a display device associated with the individual. In some cases, the consumer may configure the buying profile, such that the information maintained therein may be automatically transmitted to a device associated with an individual and the information that the consumer has determined should be inaccessible by the individual may transmitted in an encrypted state, so that the individual may not, at least, initially read the information. In some cases, upon the occurrence of a triggering event or an authorization indication provided by the user, a decryption key may be sent to the individual’s device to be used in decrypting the encrypted data or may be provided to the individual via a code, such as a QR code. In some cases, the information may be automatically transmitted to a customer related management system (CRM) associated with the seller.

The consumer may transmit and make accessible to a seller only the information the seller needs for the particular stage of the process the consumer is in. For instance, the consumer may make accessible a small subset of basic data from the buying profile when the consumer develops an initial interest in particular goods or services, such as a vehicle. The consumer may provide more information from the buying profile as the buying process progresses - such as providing driver’s license information when the consumer is prepared to conduct a test drive of the vehicle. The consumer may provide still more information from the buying profile once the consumer makes a commitment to make the purchase - such as providing financial information from the buying profile, which the seller may require as part of a credit application. In the case of a vehicle purchase, the seller may then push the received information to a third-party provider that facilitates the sale of vehicle contracts to financial lenders. Such lenders often attach stipulations as a means of verifying customer-provided information that is essential to verifying riskiness and, thus, financing terms. Such stipulations may be required for the lender to fund a loan to the consumer. Inaccuracies between the consumer-provided information and the information received in fulfillment of these stipulations may cause financing terms to change, which may cause a deal to fall through, which in turn may create a negative customer experience. In some cases, prior to the consumer providing the buying profile to a seller, information from the buying profile may be transmitted directly to the third-party provider for an automated verification of the information as it relates to common stipulations. In this case, the information for any common stipulations may be verified by the third-party provider and the buying profile may be updated with an indication of such verification. In this way, the verified information may be provided to the seller as part of the buying profile, and the seller may then provide, to the lender, such information and an indication of its verification to allow for the automated clearing of lender-required stipulations. These and other features and advantages of the disclosure will be apparent from the detailed description provided below.

### BRIEF DESCRIPTION OF THE DRAWINGS

Some features are shown by way of example, and not by limitation, in the accompanying drawings. In the drawings, like numerals reference similar elements.

FIG. 1 is a diagram of an example computing environment for an automated profile sharing system, in accordance with one or more aspects described herein.

FIG. 2 is a diagram of an example hardware configuration of an example computing device used in an automated profile sharing system, in accordance with one or more aspects described herein.

FIG. 3 is a flowchart of an example method of performing automated profile sharing functions, in accordance with one or more aspects described herein.

### DETAILED DESCRIPTION

In the following description of the various embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

Aspects discussed herein may relate to methods, systems, devices, and computer-readable media for an automated profile sharing system.

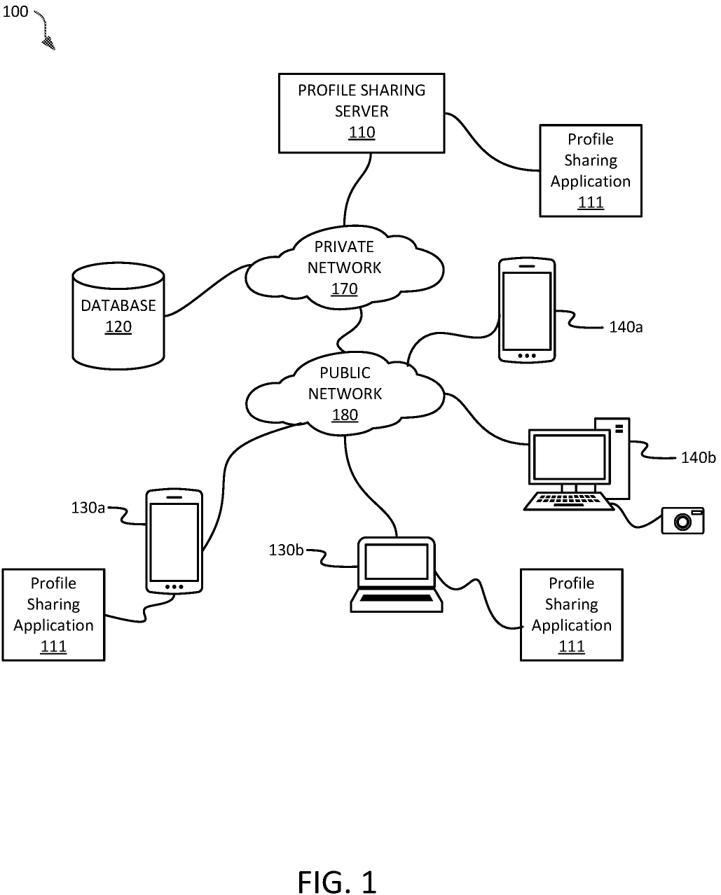

Referring to FIG. 1, an example computing environment for an automated profile sharing system is provided. An automated profile sharing system 100 may include one or more systems or computing devices, such as a profile sharing server 110, a database 120, one or more user computing devices 130 (e.g., a first user computing device 130a and/or a second user computing device 130b), one or more vendor computing devices 140 (e.g., a first vendor computing device 140a and/or a second vendor computing device 140b), a private network 170, and a public network 180. Although the various systems and computing devices in the automated profile sharing system 100 are shown and described as separate devices, one or more of the systems/computing devices may be part of a single system/computing device without departing from the scope of the disclosure.

The profile sharing server 110 may be a computing device, such as a server, used to provide functionality associated with managing and controlling access to a profile associated with a user, such as an auto buying profile, a home buying profile, or the like. The user may access the profile sharing server 110 via a website hosted by the profile sharing server 110. Alternatively or additionally, the user may access the profile sharing server 110 via a profile sharing application 111 installed on one of the one or more user computing devices 130. The profile sharing application 111 may be communicatively connected to the profile sharing server 110 via the public network 180 and/or the private network 170.

The database 120 may store information used by the profile sharing server 110, the one or more user computing devices 130, or the one or more vendor computing devices 140. The database 120 may comprise one or more of a relational database, a hierarchical database, a distributed database, an in-memory database, a flat file database, an XML database, a NoSQL database, a graph database, cloud object storage (hosted locally or within the public cloud), or the like.

The one or more user computing devices 130, e.g., the first user computing device 130a and/or the second user computing device 130b, may be configured to communicate with and/or connect to one or more computing devices of the automated profile sharing system 100 via the public network 180. In some instances, the one or more user computing devices 130 may have installed thereon one or more applications for performing one or more aspects described herein. For instance, the first user computing device 130a may have installed thereon the profile sharing application 111, for configuring and managing a profile associated with the user. In this case, the first user computing device 130a may communicate with the profile sharing server 110 via the profile sharing application 111. In some instances, the one or more user computing devices 130 may access a website hosted by and/or an application installed on the profile sharing server 110 for performing one or more aspects described herein. For instance, the second user computing device 130b may access, using a website and via the public network 180, an application such as the profile sharing application 111 installed at the profile sharing server 110 to configure and manage a profile associated with the user. In some instances, the profile sharing server 110 may be embodied in the one or more user computing devices 130.

The one or more user computing devices 130 may be any type of computing device or combination of devices capable of performing the particular functions disclosed herein. For example, the one or more user computing devices 130 may be and/or include server computers, desktop computers, laptop computers, tablet computers, smart phones, fitness devices, or the like that may include one or more processors, memories, communication interfaces, storage devices, and/or other components. The one or more user computing devices 130, in some instances, may be or include special-purpose computing devices configured to perform the functions disclosed herein. In some instances, some or all of the functionality of the profile sharing server 110 may instead be performed by any of the one or more user computing devices 130 alone or in combination with the profile sharing server 110.

The profile sharing application 111 may be an application associated with a user, such as a consumer interested in purchasing particular goods or services - such as a vehicle, a home, or the like. As will be described in further detail below, the profile sharing application 111 may be used to perform various functions associated with the purchase of particular goods or services -such as profile generation and management functions and automated profile sharing functions. The profile sharing application 111 may generate and display one of more user interfaces to facilitate these functions. The profile sharing application 111 may be a server-based application installed and executed at the profile sharing server 110. The server-based profile sharing application 111 may be accessed, through a website hosted by the profile sharing server 110, using a client device, such as the second user computing devices 130b. Additionally or alternatively, the profile sharing application 111 may be a client-based application installed and executed on a client device, such as the first user computing device 130a.

The one or more vendor computing devices 140 may be computing devices associated with vendors, such as vendors who sell vehicles, homes, or other goods or services. The one or more vendor computing devices 140 may be associated with an automobile dealership or a real estate agency for example. The one or more vendor computing devices 140 may be configured to communicate with and/or connect, via the public network 180, to one or more computing devices of the automated profile sharing system 100. In some instances, the one or more vendor computing devices 140 may have installed thereon one or more applications for performing one or more aspects described herein. For instance, the one or more vendor computing devices 140 may store an application, such as customer relationship management (CRM) application, for maintaining and managing information related to vendor customers.

In some instances, the one or more vendor computing devices 140 may have integrated therein an image capturing device for capturing an image or scanning a code, such as a bar code or a quick response (QR) code. For instance, the image capturing device may be one of one or more sensors of the first vendor computing device 140a, and one or more applications, such as a camera application or a bar/QR code reader application, installed on the first vendor computing device 140a may cause the image capturing device to be activated and to capture an image or scan a code. The captured image may be stored on the first vendor computing device 140a and/or on a different device. In some cases, the image capturing device may be used to scan a barcode, QR code, or the like generated by the profile sharing server 110 or the one or more user computing devices 130. In some instances, the one or more vendor computing devices 140 may use an image capturing device that is separately embodied from the one or more vendor computing devices 140. For instance, when separately embodied, the image capturing device may, in some cases, be communicatively connected to the one or more vendor computing devices 140, such as the second vendor computing device 140b and may be controlled by the second vendor computing device 140b. In some cases, when separately embodied, the image capturing device might not be connected to the second vendor computing device 140b and, instead, may be communicatively connected to the public network 180 and configured to transmit images to the second vendor computing devices 140b, the profile sharing server 110, and/or to other devices via the public network 180.

The private network 170 may be a network operated by, and internal to, an organization or business hosting the profile sharing server 110. The private network 170 may be used to interconnect one or more computing devices internal to the organization or business. The private network 170 may further connect to the public network 180. The private network 170 may include one or more of local area networks (LANs), wide area networks (WANs), virtual private networks (VPNs), or the like.

The public network 180 may connect the private network 170, and/or the one or more computing devices connected thereto, to one or more networks, systems, and/or computing devices that might not be associated with the organization, such as the one or more user computing devices 130 or the one or more vendor computing devices 140. The public network 180 may include one or more networks, such as the Internet.

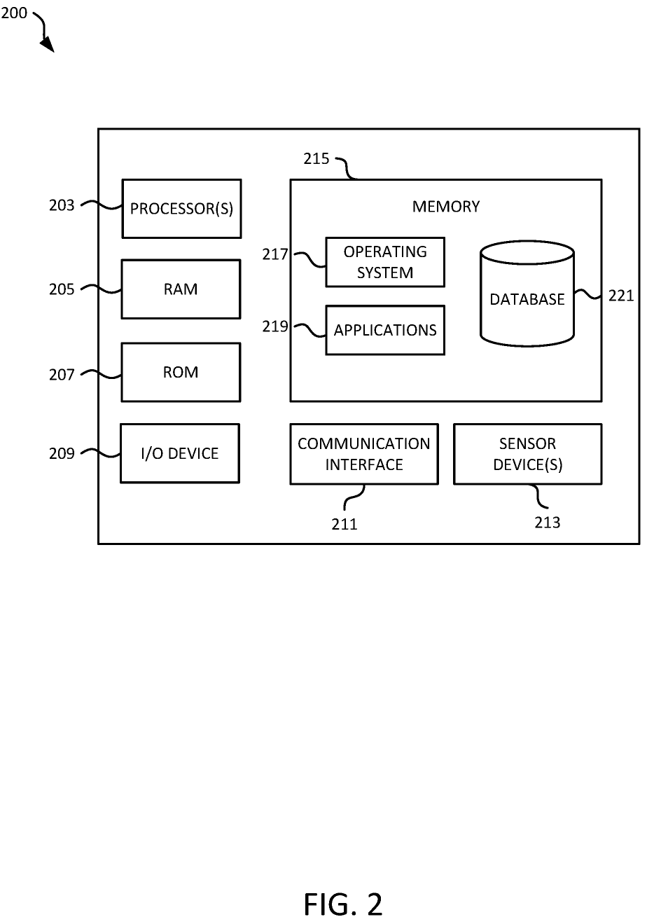

Referring to FIG. 2, an example hardware configuration of an example computing device 200 is provided. The example computing device 200 may include or incorporate any one of the profile sharing server 110, the database 120, the one or more user computing devices 130, or the one or more vendor computing devices 140. In some instances, the computing device 200 may represent, be incorporated in, and/or include various devices such as a desktop computer, a computer server, a mobile device, such as a laptop computer, a tablet computer, a smart phone, or any other types of mobile computing devices, and/or any other type of data processing device.

The computing device 200 may include one or more components, such as one or more processors 203, a random access memory (RAM) 205, a read-only memory (ROM) 207, an input/output (I/O) device 209, a communication interface 211, one or more sensor devices 213, and a memory 215. The computing device 200 may include one or more additional or different components.

The one or more processors 203 may be configured to control overall operation of the computing device 200 and its associated components. A data bus (not shown) may interconnect the one or more processors 203, the RAM 205, the ROM 207, the memory 215, the I/O device 209, the communication interface 211, and/or the one or more sensor devices 211. The one or more processors 203 may include a single central processing unit (CPU), which may be a single-core or multi-core processor, or may include multiple CPUs. The one or more processors 203 and associated components may control the computing device 200 to execute a series of computer-readable instructions to perform some or all of the processes disclosed herein. Although not shown in FIG. 2, various elements within the memory 215 or other components in the computing device 200, may include one or more caches, for example, CPU caches used by the one or more processors 203, page caches used by operating system 217, disk caches of a hard drive, and/or database caches used to cache content from database 221. For embodiments including a CPU cache, the CPU cache may be used by the one or more processors 203 to reduce memory latency and access time. The one or more processors 203 may retrieve data from or write data to the CPU cache rather than reading/writing to the memory 215, which may improve the speed of these operations. In some examples, a database cache may be created in which certain data from the database 221 may be cached in a separate smaller database in a memory separate from the database 221, such as in the RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

The I/O device 209 may include, but need not be limited to, a microphone, keypad, touch screen, and/or stylus, through which a user of the computing device 200 may provide input, and may also include one or more of a speaker for providing audio output, and a video display device for providing textual, audiovisual, and/or graphical output.

The communication interface 211 may include one or more transceivers, digital signal processors, and/or additional circuitry and software for communicating via a network (e.g., the private network 170, the public network 180, or the like), wired or wireless, using any protocol as described herein.

The one or more sensor devices 213 may include one or more of an accelerometer, a gyroscope, a GPS device, a biometric sensor, a proximity sensor, an image capturing device, a magnetometer, near-field communication (NFC) sensor, etc.

The memory 215 may store software to provide instructions to the one or more processors 203 allowing the computing device 200 to perform various actions. For example, the memory 215 may store software used by the computing device 200, such as the operating system 217, applications 219, and/or the database 221. The various hardware memory units in the memory 215 may include volatile and nonvolatile, removable and non-removable media implemented in any method or technology for storage of information, such as computer-readable instructions, data structures, program modules, or other data. The memory 215 may include one or more physical persistent memory devices and/or one or more non-persistent memory devices. The memory 215 may include, but need not be limited to, the RAM 205, the ROM 207, electronically erasable programmable read only memory (EEPROM), flash memory, or other memory technology, optical disk storage, magnetic cassettes, magnetic tape, magnetic disk storage or other magnetic storage devices, or any other medium that may be used to store the desired information and that may be accessed by the one or more processors 203.

Although various components of the computing device 200 are described separately, functionality of the various components may be combined and/or performed by a single component and/or multiple computing devices in communication without departing from the scope of the disclosure.

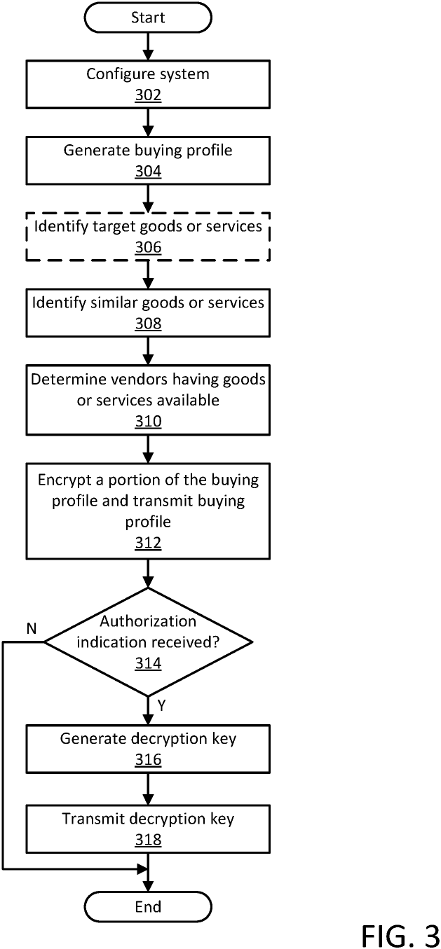

Referring to FIG. 3, a flowchart of an example method of performing automated profile sharing functions is provided. In the example method, while reference is made to the first user computing device 130a, such reference is for convenience of description only and any of the one or more user computing devices 130 may be interchangeably used.

At step 302, the profile sharing system 100 may be configured. For example, the first user computing device 130a, may receive a request to configure the first user computing device 130a with the automated profile sharing system 100. In response to the request, the profile sharing server 110 may control an application that provides computer-executable instructions for performing automated profile sharing functions to be downloaded and installed to the first user computing device 130a. For instance, the profile sharing server 110 may cause the profile sharing application 111 to be downloaded to and installed on the first user computing device 130a. In some cases, the user may use a search engine to discover the uniform resource locator (URL) of the profile sharing application 111. By mechanism of a domain name service (DNS) lookup, the user’s browser may obtain the internet protocol (IP) address of a server, such as the profile sharing server 110, that hosts the profile sharing application. Once downloaded, the profile sharing server 110 and/or the first user computing device 130a may cause the profile sharing application 111 to display one or more user interfaces for configuring the automated profile sharing system 100.

The one or more user interfaces may provide options for the user to provide authentication or security credentials for secure access to the automated profile sharing system 100. The one or more user interfaces may additionally provide options for the user to provide certain permissions to the automated profile sharing system 100. For instance, the one or more user interfaces may output options for the user to provide permission for the automated profile sharing system 100 to access certain data and/or applications installed and/or operating on the first user computing device 130a. For instance, the one or more user interfaces may provide options for the user to provide permission for the automated profile sharing system 100 to access the user’s photos, calendar data, web browsing history data, and/or other data stored on the first user computing device 130a or on another device or account (such as a social media account) associated with the user. Access to the user’s photos and/or web browsing history may be used to identify attributes or characteristics of the user’s preferred goods or services, as will be described in further detail. The one or more user interfaces may additionally output an option for the user to provide permission for the automated profile sharing system 100 to access location information associated with the first user computing device 130a, such as GPS data, Wi-Fi data, and/or cellular data, in order to identify a location of the first user computing device 130a and the user. The location information may be used by the automated profile sharing system 100 to identify the user’s proximity to one or more vendors having the user’s preferred goods and/or services available. The one or more user interfaces may additionally output options for the user to provide permission for the automated profile sharing system 100 to access an application operating on the first user computing device 130a - such as a camera application, a bar code reading application, and/or a QR code reading application. The one or more user interfaces may provide additional options for configuring the automated profile sharing system 100. After the user provides inputs for configuring the automated profile sharing system 100, the first user computing device 130a and/or the profile sharing server 110 may store the corresponding user configuration data in the database 120 and/or to a memory associated with the first user computing device 130a.

At step 304, the profile sharing server 110 and/or the first user computing device 130a may cause the profile sharing application 111 to display one or more user interfaces for generating a buying profile. The one or more user interfaces may provide options for the user to enter information associated with the purchase of goods or services. For instance, the one or more user interfaces may collect personal information about the user, such as a name, address, phone, email address, or the like.

The one or more user interfaces may also provide options for the user to enter preferences or attributes associated with particular goods or services the user wishes to purchase. For instance, the user may be interested in purchasing a vehicle and may provide preferred features or attributes associated with a preferred vehicle. For example, the user may provide information identifying a preferred vehicle color, vehicle size, transmission type, model year, wheel size, price range, and/or the like. As another example, if the user is interested in purchasing a home, the user may provide information identifying a preferred home, such as a number of bedrooms, a number of bathrooms, minimum square footage, zoned schools, geographic location, or the like. In some instances, the user need not manually enter the preferred features or attributes, and the profile sharing server 110 and/or the first user computing device 130a may, instead, automatically identify the preferred features or attributes.

For instance, in the case of goods, the profile sharing server 110 and/or the first user computing device 130a may cause the profile sharing application 111 to provide, via the one or more user interfaces, an option for the user to upload a picture of the preferred goods, and the profile sharing server 110 and/or the first user computing device 130a may identify, from the picture, the preferred goods. For example, the user may upload a picture of a vehicle, and the profile sharing server 110 and/or the first user computing device 130a may use one or more computer vision techniques to identify the vehicle in the picture. The first user computing device 130a may employ techniques such as optical recognition, edge detection, grey-scaling, object detection, semantic segmentation, or the like to detect objects in the picture. For example, the first user computing device 130a may detect a vehicle in the uploaded picture. The profile sharing server 110 and/or the first user computing device 130a may then compare the detected object to a database of objects to identify the detected object. The database of objects may be maintained in the database 120 or, in some cases, in one or more databases maintained by one or more third parties. For example, the detected vehicle may be compared to a database of known vehicles to identify the make, model, trim, year, or the like of the detected vehicle. Upon identifying the goods in the picture, the profile sharing server 110 and/or the first user computing device 130a may use the database 120 or one or more third party databases to look up attributes and/or features associated with the identified goods. For example, the profile sharing server 110 and/or the first user computing device 130a may use the database 120 or one or more third party databases to look up attributes and/or features associated with the identified vehicle. The profile sharing server 110 and/or the first user computing device 130a may cause the profile sharing application 111 to prepopulate the one or more user interfaces for entering preferences or attributes with the attributes and/or features associated with vehicle identified in the picture. The user may further modify, delete, or add to the prepopulated data via the one or more user interface.

In some cases, rather than uploading a picture of the preferred goods for automatically retrieving the preferred features and attributes, the profile sharing server 110 and/or the first user computing device 130a may receive, via the profile sharing application 111, a link to a web page that may include an image of the preferred goods, and the profile sharing server 110 and/or the first user computing device 130a may use one or more computer vision techniques to identify one or more objects of interest in the web page image. Once identified, the profile sharing server 110 and/or the first user computing device 130a may use the method described above to identify the features and attributes of the identified object.

Rather than using pictures of the preferred goods, in some cases, the profile sharing server 110 and/or the first user computing device 130a may receive, via the profile sharing application 111, a link to the web page that may provide textual details, rather than an image, about particular goods in which the user may be interested. For example, the web page may include a listing for a home and may include textual details regarding the details associated with the home. The profile sharing server 110 and/or the first user computing device 130a may extract text, links, and/or objects from the raw HTML scripts and tags that may be displayed and viewed within the user’s web browser or the network request calls made by an application hosting the web page. In this way, the profile sharing server 110 may retrieve dynamic data that provides the textual details related to the particular goods. Additionally or alternatively, source elements from the web page may be used to identify relevant information associated with the particular goods, such as by selecting appropriate HTML tags from which to extract text.

In some cases, the profile sharing server 110 and/or the first user computing device 130a may use various image processing techniques to analyze the web page and identify text that corresponds to features and/or attributes of a home. In some instances, the first user computing device 130a may identify the various features and/or attributes using machine learning techniques. For instance, the first user computing device 130a may use various machine learning models and/or algorithms, such as, but not limited to, supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. The machine learning model or algorithm may be trained to recognize various elements of web pages of home listings, by analyzing web pages associated with home listings to identify patterns, sequences, relationships, and the like, such that the model/algorithm may be able to determine those elements identifying features and/or attributes of the home. Additional information related to features and attributes may be obtained from analyzing other web pages through web scraping (e.g., web pages of news articles to discover trending vehicles in the user’s area), or from accessing a database, such as a third-party database via an application programming interface (API), that collects, organizes, and makes such information available for consumption. Upon identifying such features and/or attributes, the profile sharing server 110 and/or the first user computing device 130a may cause the profile sharing application 111 to prepopulate the one or more user interfaces for entering preferences or attributes with the identified features and/or attributes.

In some cases, the profile sharing server 110 and/or the first user computing device 130a may, with permission, access a web browsing history of the user to identify goods or services the user has searched for within a predetermined period of time. The profile sharing server 110 and/or the first user computing device 130a may cause the profile sharing application 111 to display, via the one or more user interfaces, goods or services detected in the user’s web browsing history and may request the user to confirm one or more of the goods or services as those the user is interested in purchasing and generating a buying profile for. For example, the profile sharing server 110 and/or the first user computing device 130a may detect that the user has searched for one or more vehicles in the past week. The profile sharing server 110 and/or the first user computing device 130a may detect the vehicles on the searched web pages using various computer vision techniques such as those described above and/or based on extraction from web page source code shown within a browser. The profile sharing server 110 and/or the first user computing device 130a may cause the profile sharing application 111 to display, via the one or more user interfaces, the identified vehicles and request the user’s confirm of whether one or more of the identified vehicles is a preferred vehicle which the user may be interested in purchasing. Based on receiving confirmation that one or more of the identified vehicles in a preferred vehicle, the profile sharing server 110 and/or the first user computing device 130a may use the database 120 or one or more third party databases to determine attributes and/or features associated with the identified preferred vehicle and then prepopulate the one or more user interfaces with the determined attributes and/or features. The user may further modify, delete, or add to the prepopulated data via the one or more user interface.

In some cases, rather than automatically retrieving the preferred features and attributes from an image, or a web page, or the like, the user may enter identifying information about the goods and such identifying information may be used to query a database for matching goods and their associated features and attributes. For example, the profile sharing server 110 and/or the first user computing device 130a may cause the profile sharing application 111 to provide, via the one or more user interfaces, an option for entering some form of identification information, such a vehicle identification number (VIN) or a make, model, trim, and/or year or the like to identify a vehicle, or an address to identify a home, etc. As described above, the profile sharing server 110 and/or the first user computing device 130a may use the database 120 or one or more third-party databases to then determine attributes and/or features associated with the identified vehicle or home. For example, the attributes and/or features may include the presence of a moon roof, ventilated or heated seat, a number of doors, a seating capacity, an engine type, exterior and interior color, etc.

In some cases, the profile sharing application 111 may integrate with an inventory system, such as hosted by the one or more vendor computing devices 140, to identify available inventory. In this case, the profile sharing application 111 may provide one or more user interfaces that display a list of inventory items or pictures of inventory items. The one or more user interfaces may provide options for the user to indicate a preference for one or more of the displayed inventory items (e.g., the user may “like” or “dislike” one or more of the inventory items). Based on the inventory items that the user indicates as “likes,” the profile sharing server 110 and/or the first user computing device 130a may identify one or more attributes and/or features associated with the liked inventory items. In some cases, the identified attributes and/or features may be an aggregate of all of the attributes/features associated with each of the liked inventory items. In some cases, the identified attributes and/or features may be those that the liked inventory items have in common - e.g., those that the profile sharing server 110 and/or the first user computing device 130a infer are preferred by the user based on a shared commonality. For instance, the user may “like” multiple vehicles that share the same body style, e.g. sedans. In this case, the profile sharing server 110 and/or the first user computing device 130a may identify “sedans” as one of the attributes/features. In some cases, machine learning techniques, including but not limited to unsupervised machine learning (e.g., K-means clustering of the liked inventory items) or supervised machine learning using data from previous interactions of other users of the profile sharing system 100, may be employed to extract common or similar features from among the liked items. The profile sharing server 110 and/or the first user computing device 130a may prepopulate the one or more user interfaces with the identified attributes and/or features. The user may further modify, delete, or add to the prepopulated data via the one or more user interface.

The one or more user interfaces may additionally provide an option for the user to indicate a subjective importance of one or more of the preferred features or attributes. For instance, while the user may identify many preferred features or attributes, it may be the case that only some of the preferred attributes or features are particularly important to the user (e.g., all of the selected vehicles happened to be grey, but the user will be satisfied with any color so long as other conditions are met). Accordingly, the user may indicate, via the one or more user interfaces, a degree of importance for one or more of the preferred features or attributes - such as, “must have,” “very important,” “somewhat important,” “neutral,” “preferred but not important” or the like. The one or more user interfaces may provide different options for identifying the importance of the preferred features or attributes, such as a numerical score (e.g., 5, 4, 3, 2, 1, or the like), a star system (e.g., 5 stars, 4 stars, etc.), or the like. These preferences may be updated over the course of the buying process as a result of a customer re-evaluating which features may be important, subject to their budget, inventory constraints, or discovering new features not previously identified as important based on, for example, touring homes, taking test drives, or the like.

In addition to the personal information and preferences for the goods or services the user is interesting in purchasing, the profile sharing server 110 and/or the first user computing device 130a may cause the profile sharing application 111 to provide one or more user interfaces for financial information that may be necessary for the seller to make financing, credit, and/or related decisions, or other information generally necessary during the buying process. For instance, the one or more user interfaces may provide options for collecting data that may typically be needed for a financing or credit application, such as proof of income, residency information, tax forms, copies of paystubs, prequalification letters, or the like. Alternatively or additionally, the one or more user interfaces may provide options for collecting other data that may typically be needed for other stages of the buying process - for example, a copy of driver’s license, insurance information, or the like for test driving a vehicle. In some cases, when such information is input into the one or more user interfaces, the information may be verified for accuracy or authentication by one or more third party devices. And an indication, which might not be editable by the user, of the verification status of one or more of the items of information may be associated with each information item and maintained in the buying profile. Such indications of verification may be useful in providing sellers and/or lenders of credit or financing with confidence in the information provided by the user.

The one or more user interfaces may additionally provide an option for the user to indicate a distance the user is willing to physically travel to purchase, tour, test drive, etc. the goods and/or services.

Based on the personal information, the preference information, the financial information, and other information collected by the one or more user interfaces, the profile sharing server 110 and/or the first user computing device 130a may cause the profile sharing application 111 to generate a buying profile associated with the user. The profile sharing server 110 and/or the first user computing device 130a may generate more than one buying profile for the user. For instance, the profile sharing server 110 and/or the first user computing device 130a may generate different buying profiles for different goods or services the user is interested in purchasing. The profile sharing server 110 and/or the first user computing device 130a may store the one or more buying profiles in the database 120 and/or to a memory associated with the first user computing device 130a.

At step 306, the profile sharing server 110 and/or the first user computing device 130a may identify, based on the preferred features or attributes stored in the buying profile, target goods or services. For example, where the user, at step 304, manually entered a list of preferred features and attributes for a particular type of goods, such as for a vehicle, the profile sharing server 110 and/or the first user computing device 130a may query a database, such as the database 120 or one or more third party databases, to identify a particular or a target vehicle having a threshold amount of the user-supplied features or attributes having an importance value meeting a threshold importance. The profile sharing server 110 and/or the first user computing device 130a may further store the identified target goods or services in the buying profile. In some cases, step 306 may be optional. For instance, at step 304, the user may have already identified particular or target goods, such as by providing a picture of the particular goods or uploading information identifying the particular goods. In such cases, this step may be skipped.

At step 308, the profile sharing server 110 and/or the first user computing device 130a may identify other goods or services that may be similar to the target goods or services identified at step 306 or the preferred goods or services input at step 304. An algorithmic mechanism of computing similarity between the user’s target goods or services and other goods or services may be used to identify other options that may be the most appealing to the user. For instance, if the target goods is a vehicle that has heated seats, a moon roof, and a grey exterior color, these features may be used to identify similar goods/services that may contain one or more of these features, taking into particular account those features that the user identified as important. The profile sharing server 110 and/or the first user computing device 130a may identify the similar goods or services using artificial intelligence, including neural networks machine learning algorithms, such as by applying one or more clustering algorithms (e.g., a K-means clustering algorithm, an agglomerative hierarchical clustering algorithm, an expectation-maximization (EM) clustering algorithm using Gaussian mixture models (GMM), a density-based spatial clustering algorithm, or a mean-shift clustering algorithm) to a data set comprising data points representing the target/preferred goods or services and a plurality of other goods or services of the same type. For example, where the goods related to vehicles, the data set may comprise data points representing a target vehicle and a plurality of other vehicles. Each of the plurality of other vehicles may be scored based on attributes or features of each and based on a weight assigned to each attribute/feature based on those indicated by the user to be important. For example, each vehicle of the plurality of other vehicles may be associated with a score, and each of the vehicles may be represented by a data point corresponding to the score. The plurality of data points may be distributed in a plurality of clusters. Each of the plurality of clusters may have a centroid point that is arbitrarily selected. However, one of the clusters may have as its centroid a data point that corresponds to the target/preferred vehicle. The vehicle corresponding to each data point may be assigned to a centroid that minimizes the Euclidean distance. A cluster may be formed from all data points where a given centroid minimizes the Euclidean distance. Next, within each cluster a new centroid may be chosen and the K-means clustering algorithm may be repeated until the cluster becomes stable. Accordingly, for the target/preferred vehicle and its corresponding data point, the similar vehicles are the ones where the corresponding data points lie in the same cluster. By way of a non-limiting example, the distance between the centroid and data points may be a weighted distance. Based on the Euclidean distance between the centroid and each data point, a vehicle corresponding to a data point is selected as a similar vehicle if the Euclidean distance is within a preconfigured threshold Euclidean distance. The data points within the preconfigured threshold Euclidean distance correspond to the vehicles that match (e.g., have sufficient and relevant similarity to) the target/preferred vehicle. Accordingly, vehicles whose data points are within the preconfigured threshold Euclidean distance from the centroid of the cluster may be determined by the first user computing device 130a to be the similar vehicles. Such techniques for identifying similar inventory items, such as vehicles, are disclosed in further detail in U.S. Pat. Application No. 17/104,684.

The profile sharing server 110 and/or the first user computing device 130a may cause the profile sharing application 111 to output to the one or more user interfaces, the similar goods or services that may be identified using the above techniques, and the user may modify, delete or add to the identified similar goods or services. Additionally, the profile sharing application 111 may output one or more user interfaces including options for the user to confirm and/or rank the relevancy of the identified similar goods or services to the user’s expressed or inferred preferences. This received information may be used as training data to the machine learning algorithms/models for future iterations of predictions and or refinement of the machine learning algorithms/models in order to provide the most accurate similarity determinations for users of the automated profile sharing system 100. The profile sharing server 110 and/or the first user computing device 130a may further store the confirmed identified similar goods or services in the buying profile.

At step 310, the profile sharing server 110 and/or the first user computing device 130a may determine one or more vendors having one or more of the preferred/target goods or services or the similar goods or services in inventory and/or available for purchase. The profile sharing server 110 and/or the first user computing device 130a may access one or more devices associated with vendors within a distance of the first user computing device 130a indicated by the buying profile. For instance, the profile sharing server 110 and/or the first user computing device 130a may access the one or more vendor computing devices 140 (and inventory data stored thereon), that are within the distance of the first user computing device 130a as specified in the buying profile, to determine whether the associated vendors have the preferred/target goods or services or the similar goods or services in inventory and/or available for purchase. In some cases, the profile sharing server 110 and/or the first user computing device 130a may be configured to access or receive, from one or more third party computing devices, such inventory data or in some cases listing data. In some cases, the profile sharing application 111 may be configured to execute a script to perform web scraping of one or more websites associated with the one or more vendor computing devices 140 to determine whether the vendors have, in inventory, the preferred/target goods or services or the similar goods or services. The profile sharing server 110 and/or the first user computing device 130a may cause the profile sharing application 111 to output a user interface or send a notification indicating the vendors identified as having the preferred, target, or similar goods or services in inventory and/or available. The user interface may further display a map indicating locations of the one or more identified vendors. In some cases, the user interface may display a list of the vendors and their corresponding locations.

At step 312, the profile sharing server 110 and/or the first user computing device 130a may encrypt a portion of the data associated with the buying profile and transmit the partially encrypted buying profile data to one or more of the one or more vendor computing devices 140 associated with one or more of the vendors identified in step 310. For instance, before the user is prepared to commit to the purchase of a vehicle from the vendor, the user may only want to share very basic information associated with the user’s buying profile, such as the user’s name, phone number, email address, etc. and may wish to block the vendor from access to other information, such as the user’s financial information, at least until the user decides to make a commitment to purchase from the vendor. However, it may make sense from an efficiency standpoint to provide the vendor with all of the information stored in the buying profile, while blocking the vendor’s ability to view all of the data until the user authorizes the vendor’s access to such data. Accordingly, prior to transmitting the buying profile data to one or more of the vendors, the first user computing device 130a may encrypt some portions of the buying profile data, such as the user’s financial information or the user’s driver’s license or insurance information or the like. The profile sharing server 110 and/or the first user computing device 130a may cause the profile sharing application 111 to output one or more user interfaces to provide options for identifying which items in the user’s buying profile should be encrypted and options for providing authorization to transmit the data associated with the buying profile to the one or more vendors identified in step 310. The buying profile data may be transmitted to the one or more vendor computing devices 140 in a manner in which the portion of data that is encrypted might not be readable to a human until decrypted, while the remaining portions may be readable. For example, the user’s name, and address, may be readable, while the user’s phone number, email, financial information, driver’s license and/or insurance information might not be readable. The ability to obscure certain information may provide the user with more control over their personal information. For instance, by obscuring a phone number or email, the user may control how and when they are contacted. For example, if the user has completed the buying process, the user may wish to avoid repeated calls, emails, or other forms for contact from sellers. However, over the course of the buying process, it may be necessary to provide this hidden information to a seller, such as for the purpose of completing a credit application.

In some cases, the buying profile data may be transmitted in a format which may allow for the data (e.g., encrypted or plain text data) to be loaded or automatically prepopulated into a customer relationship management (CRM) system associated with the one or more vendor computing devices 140. In some cases, the profile sharing server 110 and/or the first user computing device 130a may determine a web page associated with such a CRM system and may employ one or more scripts to analyze the web page. The one or more scripts may identify form fields or other information for entering customer information into the web page and may automatically populate such fields. The one or more scripts may identify the various form fields or other information on the web page based on using one or more machine learning models or algorithms that may be trained to recognize various elements of web pages associated with CRM systems, based on analyzing such web pages to identify patterns, sequences, relationships, and the like. In this way, the model/algorithm may be able to identify the various fields on the CRM web page and prepopulate fields using the received buying profile data. In some cases, the CRM system may be configured to import, via a designated file type, the buying profile data and process the imported data. The CRM may expose public APIs or endpoints that allow the profile sharing server 110 and/or the first user computing device 130a to transmit to the CRM, via a web protocol (HTTP/HTTPS), the buying profile data to be processed and made available to the CRM. In some cases, the one or more vendor computing devices 140 may store the buying profile data.

Instead of automatically transmitting the buying profile data to the one or more vendor computing devices 140 in response to determining associated vendors having the goods or services in inventory or available, the profile sharing server 110 and/or the first user computing device 130a may cause the profile sharing application 111 to output one or more user interfaces for generating a QR code, a bar code, a hyperlink, or the like associated with the buying profile data. While reference is made to the generation of a QR code here and throughout the description of FIG. 3, such reference is for convenience of description only and other methods, such as generating a bar code, a hyperlink, or the like may be interchangeably used.

The QR code may have embedded therein a URL link to a script or API configured to access the buying profile data, and may be used to provide a specified vendor with real-time, read-only access to some or all of the buying profile data for a given period of time or indefinitely. The one or more user interfaces may allow for the generation of a plurality of unique QR codes, such that each vendor to receive access to the buying profile data may receive a unique QR code. As such, each of the QR codes may be associated with a particular vendor and with varying amounts of buying profile data. The one or more user interfaces may further provide options for configuring each of the QR codes. For instance, each QR code may be configured to have an expiration date associated therewith and access to the buying profile data, via that QR code, may be terminated on the configured expiration date. In this way the user may control how long particular vendors may have access to the buying profile data. The QR code may additionally be configured to provide access to only a portion of the buying profile data and to prevent access to other portions of the buying profile data. For instance, the user may configure the QR code to provide access to only the user’s name, address, phone number, and/or email address and to prevent access to other information - such as the user’s financial information, driver’s license, or insurance information. For instance, the user’s financial information may contain information that the user may not want to disclose at an early stage of the buying process. The QR code may be configured differently for the different vendors who are to receive the QR code. The profile sharing server 110 and/or the first user computing device 130a may cause the profile sharing application 111 to output the QR code to a display associated with the profile sharing server 110 and/or the first user computing device 130a. To access the buying profile data, the vendor may scan the QR code using a QR code reader executing on a device associated with the vendor, such as the one or more vendor computing devices 140. Scanning the QR code may cause a script to execute which may provide access to some or all portions of the buying profile data until the configured expiration data associated with the scanned QR code. The accessible portions of the buying profile data may be output to a display of the device used to scan the QR code, such as a display of the one or more vendor computing devices 140. In some cases, the QR code may have embedded therein a URL, which when accessed may forward a request to the profile sharing server 110 and/or the first user computing device 130a to validate the authenticity of the request and/or the user attempting to access the URL, and may further confirm that the QR code has not yet expired. In some cases, the QR code may be wirelessly transmitted to a device associated with a vendor, such as via airdrop, Bluetooth sharing, or other wireless methods, or may be sent to a device associated with a vendor, such as via email or text message.

At step 314, the profile sharing server 110 and/or the first user computing device 130a may determine whether an authorization indication is received. The first user computing device 130a may cause the profile sharing application 111 to output one or more user interfaces that provide options for authorizing a vendor to access portions of the buying profile data that were previously inaccessible to the vendor. For example, at step 312 portions of the buying profile data may have been encrypted to prevent the vendor from accessing certain information in the buying profile -such as the user’s financial information, driver’s license or the like. However, as the buying process progresses, the user may wish to provide the vendor with additional information that may be appropriate for the particular stage of the buying process. For instance, in the case where the buying profile relates to the user’s interest in buying a vehicle, after deciding on one or more vehicles that the user may be interested in purchasing, the user may visit a vendor to conduct a test drive of a vehicle. Because most vendors require that an individual test driving a vehicle provide a driver’s license and/or insurance, the user may wish to have such data, from the buying profile previously transmitted to the one or more vendor computing devices 140 in step 312, revealed. That is, where the buying profile data was previously transmitted to the one or more vendor computing devices 140 with the driver’s license and/or insurance information encrypted or where the vendor was provided access to the buying profile data, via a QR code, but was prevented from accessing the driver’s license and/or insurance information, when the user arrives at the vendor for a test drive, the user may wish to have such data decrypted or otherwise made accessible by the vendor. In this case, the user may provide, via the one or more user interfaces of the profile sharing application 111, an authorization for the vendor to access one or more portions of the previously inaccessible data. The user may specify, via the one or more user interfaces, the portions of the buying profile that the vendor may be authorized to access and for how long.

In some cases, the authorization may be triggered by the occurrence of an event. For instance, the buying profile may be configured to automatically authorize the accessibility of certain portions of the buying profile upon the occurrence of an event. The user may configure which events trigger the authorization of access for which portions of the buying profile. For example, the user may configure the automated profile sharing system 100 to automatically authorize access to the user’s driver’s license and insurance information when the user visits the vendor’s location for a scheduled test drive. In some cases, the profile sharing server 110 and/or the first user computing device 130a may cause the profile sharing application 111 to output a user interface for scheduling a test drive with a particular vendor. The profile sharing application 111 may facilitate scheduling the test drive with the vendor for a particular day and time and may transmit the scheduling request to the one or more vendor computing devices 140. In some cases, the profile sharing server 110 and/or the first user computing device 130a may, alternatively, detect in a user’s calendar data, stored on the first user computing device 130a (or on another device or account associated with the user), an appointment for a test drive with the vendor. Upon detecting that location data associated with the first user computing device 130a indicates that the user is located at the vendor location on the scheduled date and time, the profile sharing server 110 and/or the first user computing device 130a may automatically provide the authorization indication (indicating access to the user’s driver’s license and insurance information) without the user’s input. In this way, the user may configure the automated profile sharing system 100 to automatically provide the authorization indication based on detecting the occurrence of a specific triggering event.

The authorization indication may be provided (by the user or automatically based on a configuration) at various stages of the buying process and the user may indicate, via the one or more user interfaces, which portions of the previously transmitted or previously inaccessible data may be accessed and when. For instance, the one or more user interfaces may display, for a particular buying profile, common stages of the buying process associated with that profile. For instance, where the buying profile is associated with a vehicle the user is interested in purchasing, such common stages may include: visit dealership, test drive vehicle, negotiate purchase, secure financing, etc. Each of these stages may be associated with pre-packaged information to be shared at that stage. The pre-packaged information may be default information that is commonly shared at the particular stage or may be information that the user pre-configured the buying profile to be shared at that stage. For instance, at the test drive stage, the driver’s license and insurance information may be pre-packaged information from the buying profile to be shared at the test drive stage. The user may select, via the one or more user interfaces, one of the displayed common stages for the buying profile to cause the associated pre-packaged information to be shared. For example, where the buying profile is associated with Vehicle X, the user may select, via the one or more user interfaces “Test Drive Vehicle X” when beginning test drive stage of the buying process. The one or more user interfaces may display a message indicating “To test drive Vehicle X, the dealer requires access to your driver’s license. Please provide authorization to share this information,” and the user may provide an input via the one or more user interfaces to provide an authorization indication to share the pre-packaged information with the vendor associated with the buying profile. After the user performs the test drive and decides to purchase the vehicle, the user may progress to the negotiation stage of the buying process, and the user may wish to have other portions of the data accessible to the vendor - such as the user’s financial information. Such information may be pre-packaged and associated with the negotiation stage, and the user may select, via the one or more user interfaces and from the displayed common stages, the negotiation stage to make such information accessible to the vendor.

In some cases, the user may manually provide such an authorization indication via the profile sharing application 111 by simply accessing the buying profile, via the one or more user interfaces, and selecting specific portions of the buying profile to share with the associated vendor in real-time.

If an authorization indication is received by the profile sharing server 110 and/or the first user computing device 130a, the process may proceed to step 316, otherwise the process may end.

After the authorization indication is received, then at step 316, the profile sharing server 110 and/or the first user computing device 130a may cause a decryption key to be generated for use by the one or more vendor computing devices 140 in decrypting one or more portions of the previously transmitted encryption data. In some cases, the decryption key may be provided via a QR code. In such cases, the profile sharing server 110 and/or the first user computing device 130a may generate a QR code embedded with a URL link to a script or a web page that provides the decryption key. In some cases, a decryption key need not be provided and the QR code may be embedded with a URL link to a script that provides access to a decrypted version of portions of the buying profile that the user, at step 314, authorizes the vendor to access, such as the pre-packaged information from the buying profile that is associated with the user’s buying stage or other information buying profile which the user provided an authorization for the vendor to access. The profile sharing server 110 and/or the first user computing device 130a may cause the QR code to be output, via the profile sharing application 111, to a display associated with the profile sharing server 110 and/or the first user computing device 130a. The QR code may be scanned by the one or more vendor computing devices 140 using a QR code reading application executing on the one or more vendor computing devices 140.

At step 318, the decryption key may be transmitted to the one or more vendor computing devices 140 for use in decrypting the previously transmitted encrypted portions of the buying profile data. In some cases, the decryption key may be transmitted when the one or more vendor computing devices 140 scans the QR code. In some cases, a decryption key need not be transmitted or associated with the QR code, and when the QR code is scanned an API call is made to retrieve or, the vendor may be otherwise provided access to, a decrypted version of only those portions of the buying profile that the user has authorized the vendor to access. In some cases, a decrypted version of the previously transmitted encrypted data may be transmitted to the one or more vendor computing devices.

Accordingly, a user may use the automated profile sharing system 100 to automate and control one or more portions of data to be shared with a vendor during the various stages of the buying process.

One or more aspects disclosed herein may be embodied in computer-usable or readable data and/or computer-executable instructions, such as in one or more program modules, executed by one or more computers or other devices as described herein. Generally, program modules include routines, programs, objects, components, data structures, or the like that perform particular tasks or implement particular abstract data types when executed by a processor in a computer or other device. The modules may be written in a source code programming language that is subsequently compiled for execution, or may be written in a scripting language, such as (but not limited to) HTML or XML. The computer-executable instructions may be stored on a computer-readable medium, such as a hard disk, optical disk, removable storage media, solid-state memory, RAM, or the like. As will be appreciated by one of skill in the art, the functionality of the program modules may be combined or distributed as desired in various embodiments. In addition, the functionality may be embodied in whole, or in part, in firmware or hardware equivalents such as integrated circuits, field programmable gate arrays (FPGA), or the like. Particular data structures may be used to more effectively implement one or more aspects disclosed herein, and such data structures are contemplated within the scope of computer-executable instructions and computer-usable data described herein. Various aspects disclosed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A method comprising:
receiving, by a computing device, first information indicating:
personal information associated with a user,
a plurality of preferred vehicle features, and
for each of the plurality of preferred vehicle features, an importance value associated with the preferred vehicle feature;
identifying, as a preferred vehicle, a vehicle comprising one or more of the plurality of preferred vehicle features having an importance value satisfying an importance threshold;
determining, by applying a clustering algorithm to a dataset comprising data points representing the preferred vehicle and a plurality of other vehicles, one or more vehicles similar to the preferred vehicle;
determining, based on accessing one or more vendor computing devices, a first vendor having one or more similar vehicles;
receiving, by the computing device, an authorization to encrypt a first portion of the first information, wherein the first portion of the first information comprises personal information associated with the user;
encrypting at least the first portion of the first information;
transmitting, to a first vendor computing device associated with the first vendor, the first portion of the first information;
generating, in response to receiving an authorization indication, a quick response (QR) code corresponding to a decryption key for decrypting at least the first portion of the first information;
transmitting, to the first vendor computing device and in response to receiving an indication that the QR code was accessed, the decryption key;
receiving, by the computing device and based on transmitting the first portion of the first information, an authorization to encrypt a second portion of the first information, wherein the second portion of the first information comprises additional personal information associated with the user different from the the first portion of the first information associated with the user;
encrypting at least the second portion of the first information;
transmitting to the first vendor computing device, the encrypted second portion of the first information;
generating, in response to receiving a second authorization indication, a second OR code corresponding to a decryption key for decrypting at least the encrypted second portion of the first information; and
transmitting, to the first vendor computing device and in response to receiving an indication that the second OR code was accessed, the second decryption key.

2. The method of claim 1, wherein receiving the authorization indication comprises:
receiving a user selection to generate the QR code; and
outputting, to a display associated with the computing device, the QR code, and wherein receiving the indication that the QR code was accessed comprises:
receiving, from the first vendor computing device and after outputting the QR code, a request to retrieve the decryption key.

3. The method of claim 1, wherein the authorization indication is received in response to detecting that the computing device is within a threshold proximity of a location associated with the first vendor.

4. The method of claim 1, further comprising:
retrieving calendar data associated with the user,
wherein the authorization indication is received in response to determining, based on the calendar data, a triggering event associated with a current date and time.

5. The method of claim 1, wherein receiving the first information identifying the plurality of preferred vehicle features comprises:
receiving an image of a preferred vehicle;
detecting, using one or more computer vision techniques, identifying information associated with the preferred vehicle, wherein the identifying information comprises one or more of: a make, a model, a trim, a production year, and a color of the preferred vehicle; and
retrieving, from a database and based on at least a portion of the identifying information, the plurality of preferred vehicle features.

6. The method of claim 1, wherein the clustering algorithm comprises one or more of: a k-means clustering algorithm, an agglomerative hierarchical clustering algorithm, an expectation-maximization (EM) clustering algorithm, a density-based spatial clustering algorithm, or a mean-shift clustering algorithm.

7. The method of claim 1, further comprising:
transmitting, to a second vendor computing device, the second QR code; and
determining, a web page associated with the second vendor computing device,
wherein the second QR code is configured to execute a script for interfacing with the determined web page and to cause one or more fields associated with the web page to be populated with the first information.

8. A computing device comprising:
one or more processors; and
a memory storing instructions that, when executed by the one or more processors, cause the computing device to:
determine first information associated with a buying profile associated with a user, wherein the first information comprises information identifying a preferred vehicle;
determine, by applying a clustering algorithm to a dataset comprising data points representing the preferred vehicle and a plurality of other vehicles, one or more vehicles similar to the preferred vehicle;
determine, based on accessing one or more vendor computing devices, a first vendor having one or more similar vehicles;
receive an authorization to encrypt a first portion of the first information;
encrypt at least the first portion of the first information;
transmit, to a first vendor computing device associated with the first vendor, the encrypted first portion of the first information;
transmit, to the first vendor computing device, a first quick response (QR) code configured to provide access to the encrypted first portion of the first information ;
receive, based on transmitting the encrypted first portion of the first information, an authorization to encrypt a second portion of the first information, wherein the second portion of the first information contains additional information different from the information contained in the first portion of the first information;
encrypt at least the second portion of the first information;
transmit, to the first vendor computing device, the encrypted second portion of the first information;
generate, in response to receiving an authorization indication, a second QR code configured to provide a decryption key for decrypting the encrypted second portion of the first information; and
transmit, to the first vendor computing device and in response to receiving an indication that the second QR code was accessed, the decryption key.

9. The computing device of claim 8, wherein the instructions, when executed by the one or more processors, cause the computing device to:
receive the authorization indication by causing the computing device to:
receive a user selection to generate the second QR code; and
output, to a display associated with the computing device, the second QR code, and
receive the indication that the second QR code was accessed by causing the computing device:
receive, from the first vendor computing device and after outputting the second QR code, a request to retrieve the decryption key.

10. The computing device of claim 8, wherein the instructions, when executed by the one or more processors, further cause the computing device to receive the authorization indication based on detecting that the computing device is within a threshold proximity of a location associated with the first vendor.

11. The computing device of claim 8, wherein the instructions, when executed by the one or more processors, further cause the computing device to:
retrieve calendar data associated with the user,
receive the authorization indication based on determining, from the calendar data, a triggering event associated with a current date and time.

12. The computing device of claim 8, wherein the instructions, when executed by the one or more processors, cause the computing device to:
identify the preferred vehicle by causing the computing device to:
detect, based on analyzing an image using one or more computer vision techniques, identifying information comprising one or more of: a make, a model, a trim, a production year, and a color of the preferred vehicle.

13. The computing device of claim 8, wherein the clustering algorithm comprises one or more of: a k-means clustering algorithm, an agglomerative hierarchical clustering algorithm, an expectation-maximization (EM) clustering algorithm, a density-based spatial clustering algorithm, or a mean-shift clustering algorithm.

14. The computing device of claim 8, wherein the instructions, when executed by the one or more processors, further cause the computing device to:
determine, a web page associated with the first vendor computing device,
wherein the second QR code is further configured to execute a script for interfacing with the determined web page and to cause one or more fields associated with the web page to be populated with the first information.

15. A non-transitory, computer-readable medium storing instructions that, when executed by one or more processors, cause a computing device to perform steps comprising:
determining, based on analyzing an image using computer vision techniques, a plurality of preferred vehicle features;
receiving, for each of the plurality of preferred vehicle features, an importance value associated with the preferred vehicle feature;
storing, as first information, the plurality of preferred vehicle features and, for each of the plurality of preferred vehicle features, the importance value;
identifying, as a preferred vehicle, a vehicle comprising one or more of the plurality of preferred vehicle features having an importance value satisfying an importance threshold;
determining, by applying a clustering algorithm to a dataset comprising data points representing the preferred vehicle and a plurality of other vehicles, one or more vehicles similar to the preferred vehicle;
determining, based on accessing one or more vendor computing devices, a first vendor having one or more similar vehicles;
receiving an authorization to encrypt a first portion of the first information and a second portion of the first information, wherein the first portion of the first information comprises information different from additional information contained in a second portion of the first information;
encrypting at least the first and second a portions of the first information;
transmitting, to a first vendor computing device associated with the first vendor, the first information;
generating, in response to receiving an authorization indication, a quick response (QR) code corresponding to a decryption key for decrypting the first portion of the first information, wherein the decryption key for decrypting the first portion of the first information cannot decrypt the second portion of the first information; and
transmitting, to the first vendor computing device and in response to receiving an indication that the QR code was accessed, the decryption key.

16. The non-transitory, computer-readable medium of claim 15, wherein the instructions, when executed by one or more processors, cause the computing device to perform the steps comprising:
receiving the authorization indication by:
receiving a user selection to generate the QR code; and
outputting, to a display associated with the computing device, the QR code, and
receiving the indication that the QR code was accessed by:
receiving, from the first vendor computing device and after outputting the QR code, a request to retrieve the decryption key.

17. The non-transitory, computer-readable medium of claim 15, wherein the authorization indication is received in response to detecting that the computing device is within a threshold proximity of a location associated with the first vendor.

18. The non-transitory, computer-readable medium of claim 15, wherein the instructions, when executed by one or more processors, cause the computing device to perform the steps comprising:
retrieving calendar data,
wherein the authorization indication is received in response to determining, based on the calendar data, a triggering event associated with a current date and time.

19. The non-transitory, computer-readable medium of claim 15, wherein the clustering algorithm comprises one or more of: a k-means clustering algorithm, an agglomerative hierarchical clustering algorithm, an expectation-maximization (EM) clustering algorithm, a density-based spatial clustering algorithm, or a mean-shift clustering algorithm.

20. The non-transitory, computer-readable medium of claim 15, wherein the instructions, when executed by the one or more processors, further cause the computing device to perform the steps of:
generating a second quick response (QR) code corresponding to the second portion of the first information;
transmitting, to a second vendor computing device, the second QR code; and
determining, a web page associated with the second vendor computing device,
wherein the second QR code is configured to execute a script for interfacing with the determined web page and to cause one or more fields associated with the web page to be populated with the first information.
